(19) United States
(12) Patent Application Publication
(10) Pub. No.: US 2014/0112428 A1
(43) Pub. Date: Apr. 24, 2014

(54) SYSTEM AND METHOD FOR COOLING VIA PHASE CHANGE

(71) Applicant: BABCOCK & WILCOX TECHNICAL SERVICES GROUP, INC., Lynchburg, VA (US)

(72) Inventors: Timothy A. Policke, Forest, VA (US); Erik T. Nygaard, Lynchburg, VA (US); Scott B. Aase, Aiken, SC (US)

(73) Assignee: BABCOCK & WILCOX TECHNICAL SERVICES GROUP, INC., Lynchburg, VA (US)

(21) Appl. No.: 13/659,218

(22) Filed: Oct. 24, 2012

(51) Int. Cl. G21C 15/04; F28D 1/047

(52) U.S. Cl. 376/373; 165/104.27

(57) ABSTRACT

The present invention relates generally to the field of cooling systems and/or methods for cooling a heated, fissioning, or exothermic solution. In one embodiment, the present invention relates to a cooling system, and method of utilizing same, for cooling a heated, fissioning, or exothermic solution that utilizes submerged cooling coils where the system of the present invention relies on a combination of multiple factors to achieve the desired effect. In one embodiment, the present invention relates to a cooling system, and method of utilizing same, for cooling a heated, fissioning, or exothermic solution that utilizes submerged cooling coils where the system of the present invention relies on the combination of: (i) cooling coil geometry; (ii) cooling coil location and design; and (iii) cooling coil operational pressure.

### FIELD AND BACKGROUND OF THE INVENTION

1. Field of the Invention

The present invention relates generally to the field of cooling systems and/or methods for cooling a heated, fissioning, or exothermic solution. In one embodiment, the present invention relates to a cooling system, and method of utilizing same, for cooling a heated, fissioning, or exothermic solution that utilizes submerged cooling coils where the system of the present invention relies on a combination of multiple factors to achieve the desired effect. In one embodiment, the present invention relates to a cooling system, and method of utilizing same, for cooling a heated, fissioning, or exothermic solution that utilizes submerged cooling coils where the system of the present invention relies on the combination of: (i) cooling coil geometry; (ii) cooling coil location and design; and (iii) cooling coil operational pressure.

2. Description of the Related Art

The use of U-tubes in heat exchange solutions are known in the art (e.g., U.S. Pat. No. 3,360,037). U.S. Pat. No. 3,360,037 discloses heat exchangers that utilize U-shaped tubes and the use of multiple U-shaped tubes in a heat exchanger that contains an annular bank of such tubes. Another factor to consider, as disclosed in U.S. Pat. No. 5,823,676, is solution movement that is created due to coiling. U.S. Pat. No. 5,823,676 discloses a convection process for use in conjunction with aqueous solutions that involves the local application of millimeter wavelength electromagnetic radiation (mm-waves) to an aqueous solution in order to generate a convection current flowing from an irradiated portion of a solution to a non-irradiated surface, where a convection vortex pattern is formed. However, none of the U-shaped tube-based cooling solutions, or systems, known to those of skill in the art are suitable for use as a cooling system, or supplemental cooling system, for a solution-based, aqueous-based, fluid-based, and/or molten-salt-based nuclear reactor.

Accordingly, given the above, a need exists in the art for a cooling system and/or method that achieves suitable cooling, or supplemental cooling, of a solution-based, aqueous-based, fluid-based, and/or molten-salt-based nuclear reactor.

### SUMMARY OF THE INVENTION

The present invention relates generally to the field of cooling systems and/or methods for cooling a heated, fissioning, or exothermic solution. In one embodiment, the present invention relates to a cooling system, and method of utilizing same, for cooling a heated, fissioning, or exothermic solution that utilizes submerged cooling coils where the system of the present invention relies on a combination of multiple factors to achieve the desired effect. In one embodiment, the present invention relates to a cooling system, and method of utilizing same, for cooling a heated, fissioning, or exothermic solution that utilizes submerged cooling coils where the system of the present invention relies on the combination of: (i) cooling coil geometry; (ii) cooling coil location and design; and (iii) cooling coil operational pressure.

Accordingly, one aspect of the present invention is drawn to a method for passively cooling a solution, the method comprising the steps of: (a) supplying one or more cooling tubes to a desired location in a container having therein at least one solution to be cooled, wherein the one or more cooling tubes are individually, or jointly, closed in nature so that the one or more cooling tubes can be positively or negatively pressurized; (b) placing a coolant in each of the one or more cooling tubes; (c) supplying at least one pressure control means to one or more of the cooling tubes, wherein the at least one pressure control means is able to positively or negatively control the pressure present in the one or more cooling tubes; and (d) controlling the pressure in the one or more cooling tubes so as to create a phase change in the coolant contained in each cooling tube thereby causing heat to be removed from the solution to be cooled.

In yet another aspect of the present invention, there is provided a method for passively cooling a solution, the method comprising the steps of: (i) supplying one or more cooling tubes to a desired location in a container having therein at least one solution to be cooled, wherein the one or more cooling tubes are individually, or jointly, closed in nature so that the one or more cooling tubes can be positively or negatively pressurized; (ii) placing a coolant in each of the one or more cooling tubes; (iii) supplying at least one pressure control means to one or more of the cooling tubes, wherein the at least one pressure control means is able to positively or negatively control the pressure present in the one or more cooling tubes; and (iv) controlling the pressure in the one or more cooling tubes so as to create a phase change in the coolant contained in each cooling tube thereby causing heat to be removed from the solution to be cooled, wherein the coolant is selected from water, a mixture of ethylene glycol and water, a solution of uranyl nitrate, a solution of uranyl sulfate, heavy water, borated water, or any suitable mixture of two or more thereof.

In yet another aspect of the present invention, there is provided a method for passively cooling a solution, the method comprising the steps of: (A) supplying one or more cooling tubes to a desired location in a container having therein at least one solution to be cooled, wherein the one or more cooling tubes are individually, or jointly, closed in nature so that the one or more cooling tubes can be positively or negatively pressurized; (B) placing a coolant in each of the one or more cooling tubes; (C) supplying at least one pressure control means to one or more of the cooling tubes, wherein the at least one pressure control means is able to positively or negatively control the pressure present in the one or more cooling tubes; and (D) controlling the pressure in the one or more cooling tubes so as to create a phase change in the coolant contained in each cooling tube thereby causing heat to be removed from the solution to be cooled, wherein the coolant is selected from water, a mixture of ethylene glycol and water, a solution of uranyl nitrate, a solution of uranyl sulfate, heavy water, borated water, or any suitable mixture of two or more thereof, and wherein the pressure in the one or more cooling tubes is controlled to be less than standard atmospheric pressure.

The various features of novelty which characterize the invention are pointed out with particularity in the claims annexed to and forming a part of this disclosure. For a better understanding of the invention, its operating advantages and specific benefits attained by its uses, reference is made to the accompanying drawings and descriptive matter in which exemplary embodiments of the invention are illustrated.

### BRIEF DESCRIPTION OF THE DRAWINGS

FIG. 1 is an illustration of a solution reactor having a cooling system in accordance with one embodiment of the present invention;

FIG. 2 is an illustration of a solution reactor having a cooling system in accordance with another embodiment of the present invention; and

FIG. 3 is an illustration of a solution reactor having a cooling system in accordance with still another embodiment of the present invention.

### DESCRIPTION OF THE INVENTION

The present invention relates generally to the field of cooling systems and/or methods for cooling a heated, fissioning, or exothermic solution. In one embodiment, the present invention relates to a cooling system, and method of utilizing same, for cooling a heated, fissioning, or exothermic solution that utilizes submerged cooling coils where the system of the present invention relies on a combination of multiple factors to achieve the desired effect. In one embodiment, the present invention relates to a cooling system, and method of utilizing same, for cooling a heated, fissioning, or exothermic solution that utilizes submerged cooling coils where the system of the present invention relies on the combination of: (i) cooling coil geometry; (ii) cooling coil location and design; and (iii) cooling coil operational pressure.

While the present invention will be described in terms of an Aqueous Homogeneous Reactor (AHR), the present invention is not limited to just AHRs. Rather, the present invention can be utilized in conjunction with any type of solution-based reactor, solution-based system, and/or exothermic system to achieve a, or supplement the, control of the system thereof regardless of whether such reactor is an AHR. Additionally, it should also be noted that the present invention could be used in a sub-critical nuclear reactor (e.g., a critical experiment or a driven fissile solution designed to stay sub-critical). Furthermore, in another embodiment, the system of the present invention can be utilized to provide a desired amount of cooling to any solution-based system where heat needs to be controlled, mitigated, and/or removed from one or more solutions.

In another embodiment, the system, or method, of the present invention presents a system and method (or a supplement thereto) for heat control in, for example, a solution-type nuclear reactor. A solution-type nuclear reactor is one means by which one can produce medical isotopes from a nuclear fission reaction. However, solution-type reactors are not limited to just medical isotope production applications as such reactors tend to offer the benefit of better stability. Although the present invention will be described in relation to an Aqueous Homogenous Reactor (AHR), a type of solution reactor, the present invention is not limited solely thereto. Rather, the present invention can be applied to a variety of nuclear reactor designs including, but not limited to, all types of solution-based, aqueous-based, fluid-based, and/or molten-salt-based nuclear reactors.

In one embodiment, the cooling system described herein comprises both a method and structural design that enables one to alter, or control, the amount of heat in a reactor solution in a solution-based nuclear reactor. In another embodiment, the cooling system described herein comprises both a method and structural design that enables one to alter, or control, the amount of heat in a solution in a solution-based system, process or reaction regardless of whether or not the application is a nuclear reactor.

One of the features of the present invention is the ability to tailor the system geometry as needed. In one embodiment, the system and method of the present invention relies upon one or more appropriately placed U-shaped tubes which are designed to accept heat from a solution in which such one or more U-shaped tubes are submerged. In one embodiment, the present invention seeks to provide sufficient cooling, or to sufficiently supplement cooling, by the placement of the one or more U-shaped tubes. For example, in a solution-based nuclear reactor application the placement of the one or more U-shaped tubes are in one or more relatively low worth areas of a reaction chamber of a solution-based nuclear reactor. In another embodiment, it may be desirable to place the one or more U-shaped tubes in one or more relatively high worth areas of the reaction chamber of a solution-based nuclear reactor. In still another embodiment, it may be desirable to place one or more U-shaped tubes in both one or more low worth areas and one or more high worth areas.

In still another embodiment, it may be desirable to place the one or more U-shaped tubes (i.e., U-shaped cooling tubes) in one or more areas in the solution to be cooled that are known “hot spots.” In this embodiment, the one or more U-shaped cooling tubes of the system of the present invention are able to further facilitate the efficient removal and/or transfer of heat from a solution to be cooled.

Although the present invention and method for use thereof are described in connection with U-shaped tubes, the present invention is not limited thereto. Rather, various other tube geometries can be utilized in connection with the present invention. For example, one or more of the U-shaped tubes described herein can be replaced with one or more helically-shaped tubes; one or more straight-shaped tubes; one or more “S-shaped tubes” tubes having at least one, at least two, at least three, or even four or more an S-shaped bends therein. In another embodiment any combination of U-shaped tubes, straight-shaped tubes, or tubes having one or more S-shaped bends therein can be used as the one or more tube of the present invention. In still another embodiment, any tube geometry can be utilized in connection with the present invention so long as the one or more tubes that are utilized in connection with the present invention are closed (or able to be closed) so that the one or more tubes can be filled with one or more suitable heat transfer media.

The next consideration to be taken into account with regard to the system and method of the present invention is the operating pressure inside the one or more cooling, or heat-exchange, tubes (e.g., U-shaped tubes). In one embodiment, where the compound used as a coolant inside the one or more cooling, or heat-exchange, tubes is water, the operating pressure inside the one or more cooling, or heat exchange, tubes (e.g., the U-shaped tubes) of the present invention is selected to be below atmospheric pressure. In this embodiment, since the pressure in the one or more cooling, or heat exchange, tubes is below atmospheric this permits a phase change in the water from liquid to vapor (via boiling) to occur at a temperature lower than 100° C. (the temperature that water boils at at standard atmospheric pressure and temperature (i.e., less than 1 atmosphere or less than 760 mm Hg and 25° C.)). In another embodiment, compounds other than water can be utilized as the “coolant” in the one or more cooling, or heat-exchange, tubes of the present invention. Suitable coolant compounds include, but are not limited to, water, a mixture of ethylene glycol and water, a solution of uranyl nitrate, a solution of uranyl sulfate, heavy water, borated water, or any suitable mixture of two or more thereof, any suitable mixture of three or more thereof, or even any suitable mixture of four or more thereof. Given the nature of the coolant compound in the one or more cooling, or heat-exchange, tubes, and the pressure and temperature conditions therein, the temperature at which phase change will occur varies, or can be varied, across a wide range. As such, the present invention is not limited to any particular range, or even single, phase change temperature. Rather, as would be known to those of skill in the art, the phase change temperature can be adjusted by controlling the temperature, pressure, and type of coolant in the one or more cooling, or heat-exchange, tubes of the present invention. Given the above, the larger the temperature gradient in the one or more cooling, or heat-exchange, tubes of the present invention the larger the heat transfer rate. As such, in one embodiment of the present invention, the temperature gradient in the one or more cooling, or heat-exchange, tubes is maximized as much as possible while considering the other design parameters of the system of the present invention. Additionally, in one embodiment the system and method of the present invention also permits control of the pressure in the one or more cooling, or heat exchange, tubes contained therein. In this embodiment, due to this feature a phase change reaction can be controlled, or managed, as a function of the temperature. As such, it is possible for the system, or method, of the present invention to control the flow of heat via the heat transfer accomplished through boiling off heat transfer media, or coolant. If so desired, the system and method of the present invention can be designed to transfer the “captured heat” to another location. For example, the capture heat can be, if so desired, transferred, to another location to drive a heat-based process such as system designed to produce power from waste heat.

Given the above, the present invention will now be discussed in detail as applied to a solution-based nuclear reactor (e.g., an AHR). Regardless of the application, the cooling of heated, fissioning, or exothermic solutions is of significant safety and/or reliability concern for the facility in which they are contained. Heat removal systems seeking to maximize reliability without comprising safety usually attempt to minimize the number of pumps, motors, blowers, and other mechanically driven systems. One such method is the usage of a phase changing coolant or, in layman's terms, a boiling coolant.

Regarding boiling, boiling is an ideal mechanism for the movement of mass and energy because of its large volume (relative to the liquid state), low density which causes it to be buoyant, and large heat transfer coefficients. Given this, the system of the present invention is designed to take advantage of these first two phenomena. As the coolant reaches its boiling point, a phase change occurs and the more buoyant gas separates itself from the liquid phase. The gas then rises through the system to a cooler environment and transmits its heat to a desired environment. After transmitting a suitable amount of heat to another environment, the gas then condenses back into the liquid phase and returns to the “hotter” portion of the cooling system.

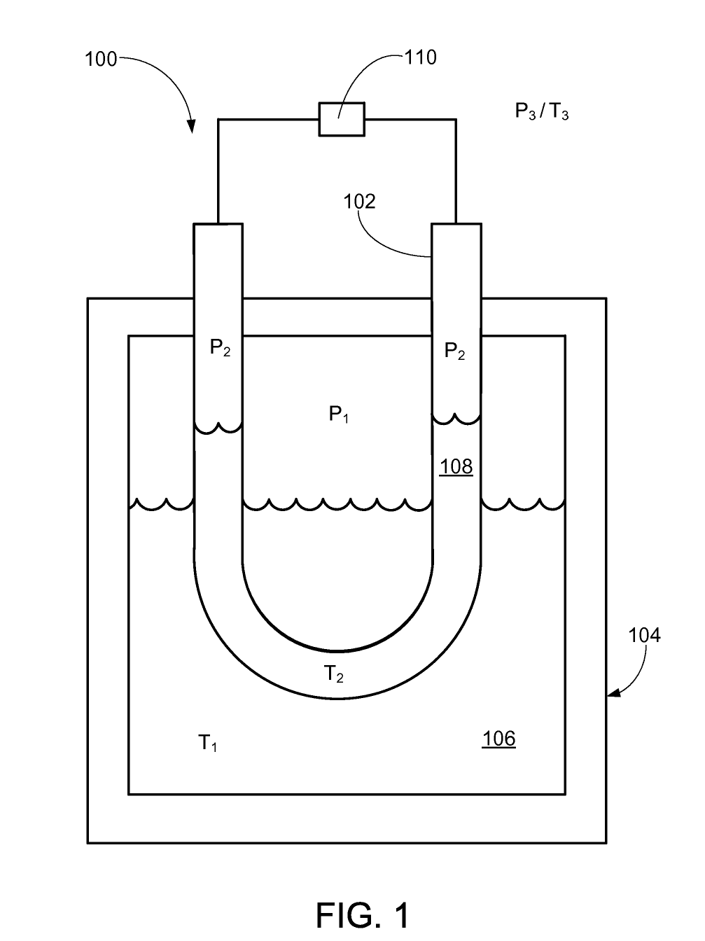

Based on the above principle, an exemplary system 100 will be described with reference to FIG. 1. FIG. 1 illustrates a cooling system 100 in accordance with one embodiment of the present invention. As illustrated therein, system 100 of the present invention comprises at least one U-shaped cooling tube 102 located in a solution reactor 104 having a solution 106 of fissionable material located therein as represented by the simplified reactor chamber of FIG. 1. The size, diameter, and height of the one or more U-shaped cooling tubes 102 is not critical and is chosen based on the amount of heat that is needed to be removed from, for example, reaction solution 106 that is contained in solution reactor 104. While FIG. 1 illustrates only one U-shaped cooling tube 102, the present invention is not limited to just this embodiment. Rather, any suitable number of U-shaped cooling tubes 102 can be utilized in the reaction chamber of solution reactor 104. It should be noted that the one or more cooling tubes 102 are either individually, or jointly, closed so that coolant 108 located in each of the one or more cooling tubes 102 is prevented from escaping. System 100 also contains at least one pressure control means 110 for controlling, either individually or jointly, the pressure of the coolant in each of the one or more cooling tubes 102.

Given the above, in one embodiment, the chosen geometry (i.e., the size, diameter, and height of the one or more U-shaped cooling tubes 102) and the operating pressure of system 100 are factors in determining the cooling effectiveness of system 100. In another embodiment, the size and/or shape and the location of the U-shaped cooling tubes 102 that are submerged in the heated, fissioning, or exothermic solution needs to be considered. In this embodiment, the geometry alters the heat transfer rate, gas flow rate, and condensation rate, amongst other parameters. The geometry can also contribute to the stability and safety of system 100 of the present invention.

Another factor to be considered is the pressure in the one or more U-shaped cooling tubes 102 of system 100. The pressure in the one or more U-shaped cooling tubes 102 of system 100 dictates the temperature at which the coolant contained therein changes phase. Thus, in one embodiment, system 100 of the present invention includes a pressure control means (e.g., a pressure controller, pressure regulator, pressure relief valves, surge volumes, etc.) that permits system 100 to control the pressure in the one or more U-shaped cooling tubes 102 thereby permitting the controlled removal of heat from the system via the control of the phase change of the coolant contained in the one or more U-shaped cooling tubes 102.

In one embodiment, the pressure utilized in the one or more U-shaped cooling tubes of system 100 is less than standard atmospheric pressure (i.e., less than about 1 atmosphere or less than about 760 mm Hg). In another embodiment, the pressure utilized in the one or more U-shaped cooling tubes of system 100 is any suitable pressure regardless of whether such pressure is above or below standard atmospheric pressure. In the instance where the pressure utilized is below, or less than, standard atmospheric pressure (i.e., less than 1 atmosphere or less than 760 mm Hg), relatively cool solutions (i.e., less than about 100° C.) can be cooled further. Additionally, further cooling is possible through the use of a desirable coolant. As noted above, suitable coolants for use in conjunction with the present invention include, but are not limited to, water, a mixture of ethylene glycol and water, a solution of uranyl nitrate, a solution of uranyl sulfate, heavy water, borated water, or any suitable mixture of two or more thereof, any suitable mixture of three or more thereof, or even any suitable mixture of four or more thereof.

Thus, in light of the above, in one embodiment a cooling system 100 in accordance with the present invention utilizes one or more U-shaped cooling tubes 102 that are submerged in a heat-containing, fissioning, or exothermic solution. The one or more U-shaped (or one or more helically-shaped tubes; or one or more straight-shaped tubes; or one or more tubes having at least one, at least two, at least three, or even four or more S-shaped bends therein, or any suitable combination thereof) cooling tubes 102 are filled with a suitable liquid coolant compound as discussed above. In operation, the coolant in the one or more U-shaped (or one or more helically-shaped tubes; or one or more straight-shaped tubes; or one or more tubes having at least one, at least two, at least three, or even four or more S-shaped bends therein, or any suitable combination thereof) cooling tubes 102 is permitted to absorb and transport heat via a phase change reaction. Given that the pressure in the one or more U-shaped (or one or more helically-shaped tubes; or one or more straight-shaped tubes; or one or more tubes having at least one, at least two, at least three, or even four or more S-shaped bends therein, or any suitable combination thereof) cooling tubes 102 is, in this embodiment, below standard atmospheric pressure (i.e., less than 1 atmosphere or less than 760 mm Hg), the gas created by the phase change of the liquid coolant contained in the one or more U-shaped cooling tubes 102 travels upward and into a cooler region thereby transferring heat from a hotter area to a cooler area. As noted above, system 100 of the present invention can, in one embodiment, be designed to capture the heat transferred from the hotter region (in this embodiment the reaction solution of a solution nuclear reactor) and utilize such heat for a variety of industrial purposes or processes (for example, for the generation of additional power via known waste heat energy producing processes). Once in the cooler region of the system, the gas transfers (or rejects) its heat, condenses back to a liquid, and returns to the hotter area. In this embodiment, the coolant is kept at a sub-atmospheric pressure which facilitates a phase change at a lower temperature thereby permitting more heat to be transferred or rejected. In another embodiment, system 100 contains a pressurization means 110 that permits one to vary the pressure of the coolant material contained in the one or more U-shaped cooling tubes 102 thereby permitting one to control the temperature at which the coolant phase changes from a liquid to a gas.

In one embodiment, the selection of the dimensions and geometrical properties of the one or more U-shaped cooling tubes 102 is important. The use, in one embodiment, of one or more U-shaped cooling tubes 102 balance two phenomena associated with induced phase change: gas transit time to a cooler region and cooling surface area. When the heated gas begins to separate from the liquid phase, buoyant forces cause the gas to travel opposite the direction of gravity. The exit speed of the gas is important because it influences the travel time from the hot region to the cooler region. Gas transit time influences a variety of system design parameters including, but not limited to, the total volume of coolant required.

From a gas dynamic standpoint, the quickest and idealized path for the gas to exit the liquid phase is a straight, upward trajectory: a straight tube. On the opposite end of the efficiency scale would be a helical coil. In a helical coil, gas inside the coil would take a longer path to reach a cooler region. However, a helical coil's potential length (and large surface area) in a given volume unit yields heat transfer advantages that decrease with increasing helical coil length. In the case of an S-shaped cooling tube, the one or more S-shaped bends therein increase the length of the one or more S-shaped cooling tubes. In an S-shaped bend, gas inside the bend would take a longer path to reach a cooler region. However, an S-shaped bend's potential length (and large surface area) in a given volume unit yields heat transfer advantages that decrease with either the increasing bend length of the S-shape or by increasing the number of S-shaped bends in an S-shaped cooling tube.

Given the above, helically-shaped cooling tubes, or S-shaped cooling tubes, can be utilized where the solution volume (or region) to be cooled is compact thereby permitting the use of the one or more efficiently sized helically-shaped cooling tubes. On the other hand, when the solution volume (or region) to be cooled is larger, it is more efficient to utilize one or more U-shaped cooling tubes. A U-shaped cooling tube reduces gas residence time when compared to a similarly sized helically-shaped cooling tube and thus permits a more efficient cooling system when the volume (or region) of solution to be cooled is large. As would be apparent to those of skill in the art, no one cut off point exists for choosing between the various different tube geometries disclosed herein. Rather, when all other design parameters are taken into consideration by one of skill in the art, a suitable geometric orientation will be ascertained in order to achieve the desired cooling capacity or system efficiency. Additionally, another factor to consider when choosing between a straight design, a helically-shaped design, an S-shaped design, or a U-shaped design, is the total volume of the one or more submerged cooling tubes. As such, in one embodiment, the use of one or more U-shaped cooling tubes presents a more compact total volume profile.

One advantage of U-shaped cooling tubes is their serviceability. Since U-shaped cooling tubes present a straightforward geometry—the inspection, maintenance, and replacement of cooling coils is rendered more efficient. This in turn increases the reliability of the cooling systems of the present invention.

The placement of the one or more U-tubes (or one or more helically-shaped tubes; or one or more straight-shaped tubes; or one or more tubes having at least one, at least two, at least three, or even four or more S-shaped bends therein, or any suitable combination thereof) within a heated, fissioning, or exothermic solution are application specific. One factor to consider is that localized cooling (concentrated cooling in a specific location of the solution) can/may cause solution movement. If the solution being cooled is to remain unmixed then localized cooling should be avoided. If, on the other hand, the solution to be cooled is to also be mixed, then it is desirable to place the one or more cooling tubes of the present invention in a location, or locations, that result in localized cooling and therefore mixing (i.e., heterogeneous cooling promotes a homogenous solution by facilitating, or causing, mixing).

In one embodiment, system 100 is controlled via pressure regulation. In one embodiment, pressure regulation is achieved via a pressure control means as described above. Varying the pressure within the one or more cooling tubes permits modification of the coolant's boiling point. By controlling the boiling point of the coolant in the one or more cooling tubes, system 100 (or 200, or 300) of the present invention is able to control the amount of heat that is transferred (or rejected) from a solution to be cooled at a point outside the solution to be cooled. Systems 100, 200 and 300 of the present invention permit cooling of a solution via a substantially reduced number of moving mechanical components (or even no moving mechanical components), a wide range of thermal operating loads, and the ability to put into place self-limiting behavior (e.g., easily quantifiable maximum temperatures).

In the case where a system in accordance with the present invention is applied to an AHR, or some other type of solution-based nuclear reactor, additional factors need to be considered. For instance, one additional consideration relates to the material utilized to form the one or more cooling tubes 102 as these tubes are placed in a solution containing fissionable material. Another consideration to take into account when applying a system of the present invention to a solution-based nuclear reactor is the creation and management of radiolytic gases.

In various nuclear applications, the neutron economy (effectiveness of neutron utilization) of a system in accordance with the present invention should be taken into consideration. Material usage plays a major role in determining whether a system has a high neutron economy (few neutrons are absorbed in a non-fissioning event) or a low neutron economy (many neutrons are absorbed in a non-fissioning event). Systems like reactors seek to have high neutron economies with the goal of maintaining criticality where criticality safety applications seek to have low neutron economies with the goal of preventing criticality. Thus, the material utilized for a system in accordance with the present invention is, in part, dictated by whether such system is to have a high neutron economy or low neutron economy. Suitable materials having a high neutron economy for use in conjunction with the present invention include, but are not limited to, zirconium-based materials or alloys, or aluminum-based materials or alloys. On the other hand, suitable materials having a low neutron economy for use in conjunction with the present invention include, but are not limited to, various steel alloys or iron-based metals/alloys. The choice of material for the one or more cooling tubes in a system in accordance with the present invention may also be a non-nuclear concern. Depending on the solution being cooled, or the coolant selection, corrosion, precipitation, acidity, and other system parameters may influence the material from which the one or more cooling tubes are to be formed.

Another nuclear specific consideration relates to the generation of radiolytic gases. In a radioactive environment, molecular bonds may be dissociated and new, potentially combustible gases may be created. Examples of radiolytic gases include, but are not limited to, hydrogen (H₂), oxygen (O₂), nitrogen-containing gas species (e.g., N₂, NO₂, NO, N₂O, NH₃, etc.), and sulfur-containing gas species (e.g., SO₂, SO₃, etc.). Accordingly, any system that generates radiolytic gases must incorporate design features that permit the reliable and safe handling of any such radiolytic gases produced. The type, complexity, and size of such radiolytic gas management systems will depend on the gas composition and generation rate.

One advantage of a system in accordance with the present invention is the efficiency with which its construction, maintenance, and operation can be achieved. Additionally, a system in accordance with the present invention permits one to achieve a wide range of applicability. Furthermore, with little or no moving parts, the maintenance of a system in accordance with the present invention is primarily related to cooling tube integrity. Also of consideration is the fact that during a cooling operation only one parameter must be controlled—the pressure of the coolant in the one or more cooling tubes—thereby permitting the efficient control and operation of a system in accordance with the present invention.

Given the above, the following exemplary relationship of the various temperatures and pressures in a system 100 will be discussed (see FIG. 1). In system 100, solution 106 has a temperature and pressure designed T₁ and P₁, while the coolant in the one or more cooling tubes 102 has a temperature and pressure designated T₂ and P₂. Finally, the location to which the heat in solution 106 is to be transmitted to, or rejected to, has a temperature and pressure designed T₃ and P₃. Given these designations, the following relationship between the various temperatures and pressures are achieved in one embodiment by system 100 so as to achieve the removal of heat from solution 106 to a desired position external to solution 106. That is, T₂ is less than T₁ and T₂ is greater than T₃. Also, P₂ is less (or even substantially less) than P₁ and P₁ is less than P₃ (thus by the transitive property P₂ is less than P₃). Given this arrangement of pressures and temperatures, heat is able to be transferred, or rejected, from a hot solution 106 to a cooler external location outside of chamber/solution container 104.

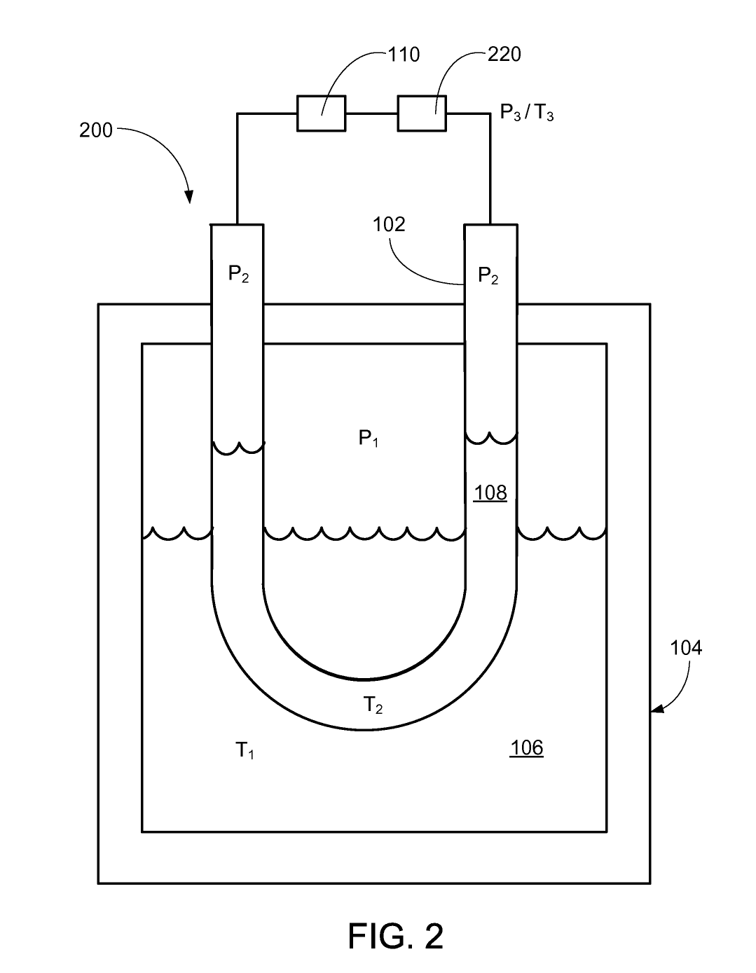

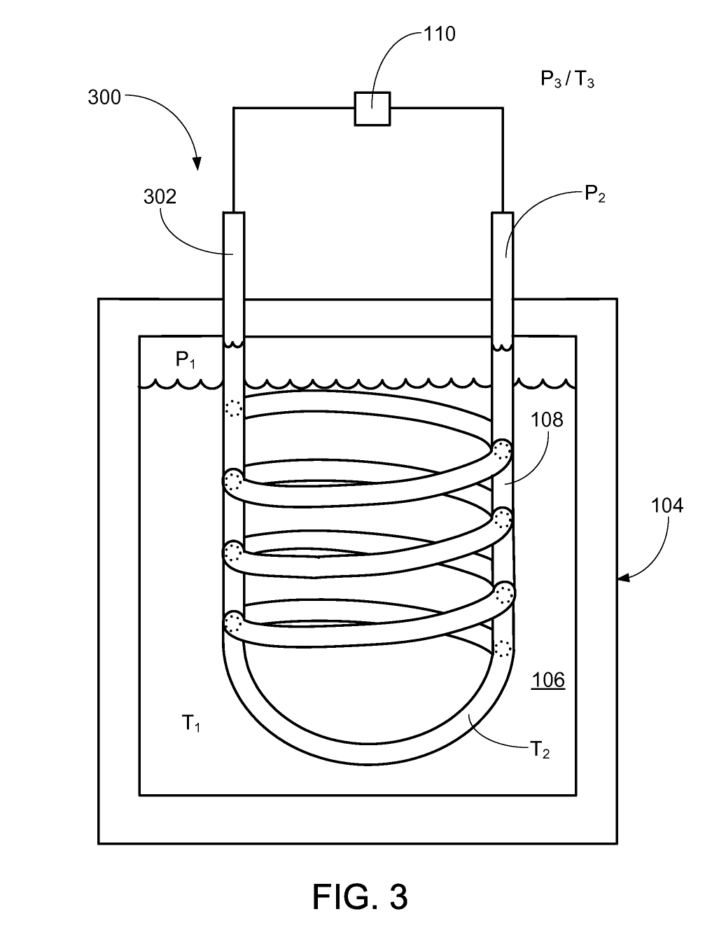

Turning to FIG. 2, FIG. 2 is identical in nature to FIG. 1 except that FIG. 2 contains a radiolytic gas control system, or means 220. Turning to FIG. 3, FIG. 3 is identical in nature to FIG. 1 except that FIG. 3 contains one or more helically-shaped cooling tubes 302 rather than the U-shaped tubes 102 of FIG. 1 and FIG. 2.

While specific embodiments of the present invention have been shown and described in detail to illustrate the application and principles of the invention, it will be understood that it is not intended that the present invention be limited thereto and that the invention may be embodied otherwise without departing from such principles. In some embodiments of the invention, certain features of the invention may sometimes be used to advantage without a corresponding use of the other features. Accordingly, all such changes and embodiments properly fall within the scope of the following claims.

What is claimed is:

1. A method for passively cooling a solution, the method comprising the steps of:
(a) supplying one or more cooling tubes to a desired location in a container having therein at least one solution to be cooled, wherein the one or more cooling tubes are individually, or jointly, closed in nature so that the one or more cooling tubes can be positively or negatively pressurized;
(b) placing a coolant in each of the one or more cooling tubes;
(c) supplying at least one pressure control means to one or more of the cooling tubes, wherein the at least one pressure control means is able to positively or negatively control the pressure present in the one or more cooling tubes; and
(d) controlling the pressure in the one or more cooling tubes so as to create a phase change in the coolant contained in each cooling tube thereby causing heat to be removed from the solution to be cooled.

2. The method of claim 1, wherein the solution to be cooled is a fissionable solution contained in a solution-based nuclear reactor.

3. The method of claim 1, wherein the solution to be cooled is a fissionable solution contained in an AHR.

4. The method of claim 1, wherein the one or more cooling tubes are selected from U-shaped cooling tubes, helically-shaped cooling tubes, straight-shaped tubes, S-shaped tubes, or a combination thereof.

5. The method of claim 1, wherein the one or more cooling tubes are selected from U-shaped cooling tubes.

6. The method of claim 1, wherein the one or more cooling tubes are selected from helically-shaped cooling tubes.

7. A method for passively cooling a solution, the method comprising the steps of:
(i) supplying one or more cooling tubes to a desired location in a container having therein at least one solution to be cooled, wherein the one or more cooling tubes are individually, or jointly, closed in nature so that the one or more cooling tubes can be positively or negatively pressurized;
(ii) placing a coolant in each of the one or more cooling tubes;
(iii) supplying at least one pressure control means to one or more of the cooling tubes, wherein the at least one pressure control means is able to positively or negatively control the pressure present in the one or more cooling tubes; and
(iv) controlling the pressure in the one or more cooling tubes so as to create a phase change in the coolant contained in each cooling tube thereby causing heat to be removed from the solution to be cooled,
wherein the coolant is selected from water, a mixture of ethylene glycol and water, a solution of uranyl nitrate, a solution of uranyl sulfate, heavy water, borated water, or any suitable mixture of two or more thereof.

8. The method of claim 7, wherein the solution to be cooled is a fissionable solution contained in a solution-based nuclear reactor.

9. The method of claim 7, wherein the solution to be cooled is a fissionable solution contained in an AHR.

10. The method of claim 7, wherein the one or more cooling tubes are selected from U-shaped cooling tubes, helically-shaped cooling tubes, straight-shaped tubes, S-shaped tubes, or a combination thereof.

11. The method of claim 7, wherein the one or more cooling tubes are selected from U-shaped cooling tubes.

12. The method of claim 7, wherein the one or more cooling tubes are selected from helically-shaped cooling tubes.

13. A method for passively cooling a solution, the method comprising the steps of:
(A) supplying one or more cooling tubes to a desired location in a container having therein at least one solution to be cooled, wherein the one or more cooling tubes are individually, or jointly, closed in nature so that the one or more cooling tubes can be positively or negatively pressurized;
(B) placing a coolant in each of the one or more cooling tubes;
(C) supplying at least one pressure control means to one or more of the cooling tubes, wherein the at least one pressure control means is able to positively or negatively control the pressure present in the one or more cooling tubes; and
(D) controlling the pressure in the one or more cooling tubes so as to create a phase change in the coolant contained in each cooling tube thereby causing heat to be removed from the solution to be cooled,
wherein the coolant is selected from water, a mixture of ethylene glycol and water, a solution of uranyl nitrate, a solution of uranyl sulfate, heavy water, borated water, or any suitable mixture of two or more thereof, and wherein the pressure in the one or more cooling tubes is controlled to be less than standard atmospheric pressure.

14. The method of claim 13, wherein the solution to be cooled is a fissionable solution contained in a solution-based nuclear reactor.

15. The method of claim 13, wherein the solution to be cooled is a fissionable solution contained in an AHR.

16. The method of claim 13, wherein the one or more cooling tubes are selected from U-shaped cooling tubes, helically-shaped cooling tubes, straight-shaped tubes, S-shaped tubes, or a combination thereof.

17. The method of claim 13, wherein the one or more cooling tubes are selected from U-shaped cooling tubes.

18. The method of claim 13, wherein the one or more cooling tubes are selected from helically-shaped cooling tubes.
